(19) United States
(12) Patent Application Publication
(10) Pub. No.: US 2018/0308049 A1
(43) Pub. Date: Oct. 25, 2018

(54) EQUIPMENT AND INVENTORY MANAGEMENT SYSTEMS AND METHODS

(71) Applicant: Katz Tech LLC, Hartsdale, NY (US)

(72) Inventor: Scott Katz, Hartsdale, NY (US)

(21) Appl. No.: 15/961,371

(22) Filed: Apr. 24, 2018

Related U.S. Application Data
(60) Provisional application No. 62/488,983, filed on Apr. 24, 2017.

(51) Int. Cl. G06Q 10/08; G06Q 10/10

(52) U.S. Cl. CPC G06Q 10/0875; G06Q 10/109

(57) ABSTRACT

According to the invention herein, a method and a system are provided. The system includes one or more user computing devices, at least one processor, and a communication network. In the method, an item is associated with a unique identifier, the item is classified with a category, and a status is assigned to the item. The status includes a location and an availability state, such as open, reserved, in-use, or misplaced. A reservation request associated with the item is received from a user device. Information related to the request is processed to determine the status of the item. Where the state of the item is reserved, in-use, or misplaced, an unavailable notification is transmitted to the user device. Where the state of the item is open, a confirmation notification is transmitted to the user device. The respective status is updated to represent that the item is reserved or in-use.

### CROSS-REFERENCE TO RELATED PATENT APPLICATIONS

This application is based on and claims priority to U.S. Provisional Patent Application 62/488,983, filed Apr. 24, 2017, the entire contents of which is incorporated by reference herein as if expressly set forth in its respective entirety herein.

### FIELD OF THE INVENTION

The present invention relates generally to front-end and back-end processing and, more particularly, to an inventory and equipment management system.

### BACKGROUND OF THE INVENTION

Despite advancements in modern technology, managing equipment and inventory remains a challenge, particularly for industries that use equipment that is carried to and from job sites by many people. Specific equipment and perishable or other inventory that may be in high demand or otherwise critical for a job, but is unavailable, unaccounted for or missing, can cause critical work-schedule delays and inconvenience that have far reaching effects and costs.

### SUMMARY OF THE INVENTION

In view of the aforementioned concerns, the present application provides systems and methods for improvements and data management, connectivity, communications and processing in connection with location-based systems and methods.

In a first aspect, a method is provided. In the method, a respective item is associated with a unique identifier by at least one processor configured to execute instructions stored on a non-transitory readable media. The respective item is classified, by the at least one processor, with a respective item category. A respective status is assigned by the at least one processor, to the item, such that the respective status comprises a respective location and a respective availability state for the item. The availability state can be open, reserved, in-use, or misplaced. A respective reservation request associated with the respective item is received by the at least one processor from a first user computing device over a communication network. The respective reservation request represents a request for exclusive use of the respective item and the respective reservation request includes a respective date and/or time, and a location for using the respective item. Further, information related to the respective item associated with the reservation request is processed by the at least one processor to determine the respective status of the item. As part of the processing, where the availability state of the respective item is reserved, in-use, or misplaced, an unavailable notification indicating that the respective item is reserved, in-use, or misplaced is transmitted by the at least one processor to the first user computing device. Where the availability state of the respective item is open, however, a confirmation notification is transmitted by the at least one processor to the first user computing device representing that the respective item is available and confirming reservation of the respective item. Further, the respective status is updated by the at least one processor to represent that the respective item is reserved or in-use.

In another aspect of the method, a completion notification representing completed use of the respective item is received by the at least one processor from the first user computing device, and the respective status is updated by the at least one processor to represent that the respective item is available. In a further aspect, the completion notification can include information representing a location of the respective item, and a date and/or time of transmission of the completion notification. In another aspect, the respective reservation request can represent a request to reserve use of the respective item in the present or in the future.

In another aspect of the method, after the unavailable notification is transmitted by the at least one processor to the first user computing device, a completion notification representing availability of the respective item is received by the at least one processor from a different user computing device. Further, the respective status of the respective item is updated by the at least one processor to represent that the respective item is available. In a further aspect, an alert indicating that the respective item having the respective item category has an availability state of open is transmitted by the at least one processor to the first user computing device.

In another aspect, a system is provided. The system includes one or more user computing devices include a first user computing device, and at least one processor comprising a non-transitory readable media, the non-transitory readable media being configured to store instructions. The system further includes a communication network configured to facilitate communication between the at least one processor and the one or more user computing devices including the first user computing device. The at least one processor is configured to execute instructions. The instructions cause the at least one processor to: associate a respective item with a unique identifier, classify the respective item with a respective item category, and assign a respective status to the item. The respective status includes a respective location and a respective availability state for the item. The availability state can be open, reserved, in-use, or misplaced. Further, instructions cause the at least one processor to receive, from the first user computing device, a respective reservation request associated with the respective item. The respective reservation request represents a request for exclusive use of the respective item and the respective reservation request includes a respective date and/or time, and a location for using the respective item. Instructions also cause the at least one processor to process information related to the respective item associated with the reservation request to determine the respective status of the item. As part of the processing of information, where the availability state of the respective item is reserved, in-use, or misplaced, the instructions cause the at least one processor to transmit, to the first user computing device, an unavailable notification indicating that the respective item is reserved, in-use, or misplaced. Where the availability state of the respective item is open, however, the instructions cause the at least one processor to transmit, to the first user computing device, a confirmation notification representing that the respective item is available and confirming reservation of the respective item. The instructions further cause the at least one processor to update the respective status to represent that the respective item is reserved or in-use.

In another aspect of the system, the at least one processor is configured to execute instructions that cause the at least one processor to receive, from the first user computing device, a completion notification representing completed use of the respective item. The instructions also cause the at least one processor to update the respective status to represent that the respective item is available. In a further aspect, the completion notification includes information representing a location of the respective item, and a date and/or time of transmission of the completion notification.

In another aspect of the system, the respective reservation request represents a request to reserve use of the respective item in the present or in the future. In another aspect, after transmission of the unavailable notification by the at least one processor to the first user computing device, instructions cause the at least one processor to receive, from a different user computing device, a completion notification representing availability of the respective item. Further, the instructions cause the at least one processor to update the respective status of the respective item to represent that the respective item is available. In a further aspect, the at least one processor is configured to execute instructions that cause the at least one processor to transmit, to the first user computing device, an alert indicating that the respective item having the respective item category has an availability state of open.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. It is noted that the drawings of the invention are not to scale. The drawings are mere schematics representations, not intended to portray specific parameters of the invention. Understanding that these drawings depict only typical embodiments of the invention and are not, therefore, to be considered to be limiting its scope, the invention will be described and explained with additional specificity and detail through the use of the accompanying drawings, in which:

FIG. 1 is a diagram illustrating an example hardware arrangement that operates for providing the systems and methods disclosed herein;

FIG. 2 illustrates, in block diagram form, an exemplary data processing apparatus and/or user computing device that can provide functionality in accordance with the teachings herein;

FIG. 3 is a simple diagram illustrating a plurality of example items that can be managed in accordance with the present application;

FIG. 4 is a process flow diagram of an example method representing interactions between backend processors and one or more user computing devices in accordance with registering a tool in one or more databases;

FIGS. 5A and 5B show a process flow diagram of an example method representing steps associated with interfacing with one or more tools in accordance with the teachings herein;

FIG. 6 shows a process flow diagram of an example method representing steps associated with similar processes illustrated in FIG. 5, but for disposable items;

FIG. 7 illustrates an example database layout in connection with a plurality of data structures;

FIG. 8 is a simple block diagram illustrating interactivity between various user computing devices in connection a foreman, job and specific example equipment and items associated therewith;

FIG. 9 is a simple block diagram and illustrates an example container, such as a carrying case that holds a collection of equipment and items; and

FIG. 10 shows a process flow diagram of another example method representing steps associated with reserving one or more items in accordance with the teachings herein.

### DETAILED DESCRIPTION

For the purposes of promoting an understanding of the principles of the invention, reference will now be made to the exemplary implementations, including as illustrated in the drawings, and specific language will be used to describe the same. It is to be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the application.

Reference throughout this specification to an “implementation,” “embodiment,” an “example” or similar language means that a particular feature, structure, characteristic, or combinations thereof described in connection with the embodiment is included in at least one embodiment of the present invention. Thus, appearances of the phrases an “embodiment,” “embodiment,” an “example,” and similar language throughout this specification may, but do not necessarily, all refer to the same embodiment, to different embodiments, or to one or more of the figures. Additionally, reference to the wording “embodiment,” “embodiment,” “example” or the like, for two or more features, elements, etc. does not mean that the features are necessarily related, dissimilar, the same.

In accordance with one or more implementations, systems, methods, and computer program products are provided herein to provide an automatic and efficient structure for effecting location-based services in accordance with the teachings herein. In one or more implementations, cloud computing is a model of service delivery for enabling convenient, on-demand network access to a shared pool of configurable computing resources (e.g. networks, network bandwidth, servers, processing, memory, storage, applications, virtual machines, and services) that is rapidly provisioned and released with minimal management effort or interaction with a provider of the service. This cloud model may include a plurality of characteristics, service models, and deployment models, as known in the art.

By way of overview and introduction, the present application provides for identifying a plurality of items, such as equipment items, inventory items, disposable items or the like that are used in the building industry, and associating each of the respective items in respective inventory database applications. One or more Internet-based computer software applications, which can include mobile apps, desktop apps, browser-based apps, or the like, operate on various devices remotely, such as in the field, and ensure current and up-to-date information is accessible by all interested parties at any time. This can be implemented, for example, as a function of QR codes that are coupled to the items and include one or more uniform resource locators (“URLs”), including to access and populate Web-based databases using simple scanning technology. In addition or in the alternative to QR codes, near field communications (“NFC”) or other technological options are suitable for providing access to web-based resources. For example, users can identify respective actions related to inventory and equipment such as to initially tag an item and add it to a database, check out a respective item, or return an item to represent that the item is generally available for use by others. In one or more implementations of the present application, each registered item (e.g. equipment, inventory, or the like) can be tagged with a respective QR code that maps to a respective Internet address which points to an object, service or other computer-based resource managed by a server or other device. Actions associated with each of the respective items can be identified and managed from the field, for example via a mobile app.

In one or more implementations of the present application, scheduling functionality is provided and associated with each of the respective items. For example, a reservation application can be integrated with one or more mobile apps that is based on dates when a particular tool will be needed for a particular job. Reservations can be made for respective item within a predetermined amount of time before the tool is needed, such as 8 hours, and individuals that have respective items in custody can be monitored to ensure that reservations are kept. Compliance with one or more reservations can be made as a function of processes operating in accordance with the present application. For example, a builder uses a tool at a jobsite and at the end of the day when the job is finished forgets to take the tool out of his car and takes it home by mistake. One or more processes executing on a computing device determines that the tool is not available for reservation made by another person. Contact information for the builder is automatically obtained and a message is generated and transmitted to the builder that alerts the builder and requests that the equipment item be returned. Repeat alerts can be generated and sent, including with increasing urgency and frequency, to ensure compliance. In one or more implementations, user computing devices, such as shown and described herein, can be configured to awaken from a sleep state in order to alert a user of a particular condition, such as an indication that a respective item that has been reserved by someone is not available.

Thus, in accordance with the teachings herein, hundreds of thousands of items owned or otherwise controlled by multitudes of businesses that are in high demand can be managed efficiently and accurately, thereby reducing or otherwise eliminating any delays or inconveniences caused by the items being unavailable or having unknown whereabouts.

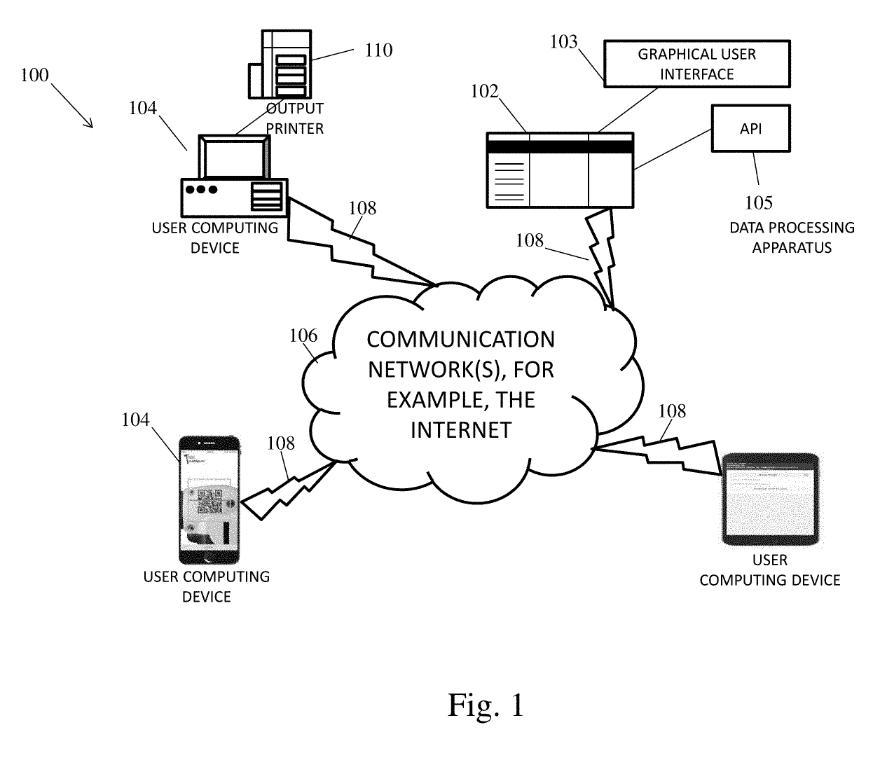

Referring to FIG. 1, a diagram is provided of an example hardware arrangement that operates for providing the systems and methods disclosed herein, and designated generally as system 100. System 100 can include one or more data processing apparatuses 102 that are at least communicatively coupled to one or more user computing devices 104 across communication network 106. Data processing apparatuses 102 and user computing devices 104 can include, for example, mobile computing devices such as tablet computing devices, smartphones, personal digital assistants or the like, as well as laptop computers and/or desktop computers that can communicate over wired and/or wireless data communication networks. Further, a computing device may be configured as a data processing apparatus 102 and a user computing device 104, depending upon operations being executed at a particular time. The software instructions can be configured as a broadcaster and can take various forms, such as a plug-in, add-in, extension or the like, that operate with an existing computer program, including a web-browser software application. Also illustrated in FIG. 1 is graphical user interface 103 and application programming interface(s) 105, which can be provided to configure data processing apparatus 102, in accordance with the teachings herein.

With continued reference to FIG. 1, data processing apparatus 102 can be configured to access one or more databases for the present application, including image files, video content, documents, audio/video recordings, metadata and other information. It is contemplated that data processing apparatus 102 can access any required databases via communication network 106 or any other communication network to which data processing apparatus 102 has access. Data processing apparatus 102 can communicate with devices comprising databases using any known communication method, including wirelessly or wired, such as via a direct serial, parallel, universal serial bus (“USB”) interface, or via a local or wide area network.

User computing devices 104 communicate with data processing apparatuses 102 using data connections 108, which are respectively coupled to communication network 106. Communication network 106 can be any communication network, but is typically the Internet or some other global computer network. Data connections 108 can be any known arrangement for accessing communication network 106, such as the public internet, private Internet (e.g. VPN), dedicated Internet connection, or dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 104 preferably have the ability to send and receive data across communication network 106, and can be equipped with cameras, microphones and software applications, including web browsers or other applications. By way of example, user computing device 104 may be personal computers such as Intel Pentium-class and Intel Core-class computers or Apple Macintosh computers, tablets, smartphones, but are not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 106, and that wireless communication can be provided between wireless devices and data processing apparatuses 102. In one or more implementations, the present application provides improved processing techniques to prevent packet loss, to improve handling interruptions in communications, and other issues associated with wireless technology.

Thus, according to implementations of the present application, user computing device 104 provides user access to data processing apparatus 102 for the purpose of receiving and providing information. The specific functionality provided by system 100, and in particular data processing apparatuses 102, is described in detail below.

Moreover, system 100 preferably includes software that provides functionality described in greater detail herein, and preferably resides on one or more data processing apparatuses 102 and/or user computing devices 104. One of the functions performed by data processing apparatus 102 is that of operating as a web server and/or a web site host. Data processing apparatuses 102 typically communicate with communication network 106 across a permanent i.e., un-switched data connection 108. Permanent connectivity ensures that access to data processing apparatuses 102 is always available.

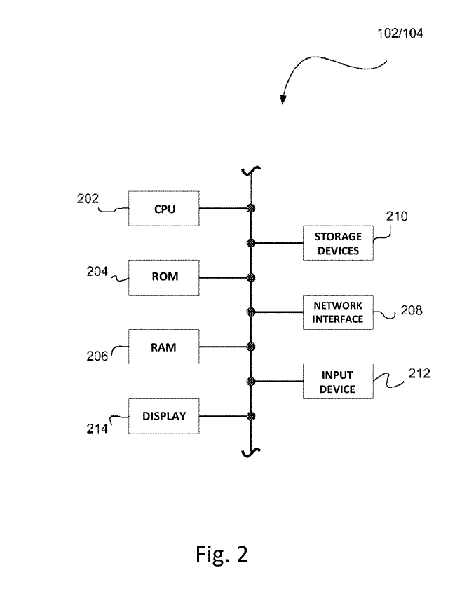

FIG. 2 illustrates example functional elements of each data processing apparatus 102 or user computing device 104, and preferably includes one or more processors 202 used to execute software code in order to control operation of data processing apparatus 102/user computing device 104, read only memory (ROM) 204, random access memory (RAM) 206 or any other suitable volatile or non-volatile computer readable storage medium, which can be fixed or removable. FIG. 2 also includes one or more network interfaces 208 to transmit and receive data to and from other computing devices across a communication network. The network interface 208 can be any interface that enables communication between the any of the devices (e.g., 102 or 104) shown in FIG. 2 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the devices and/or communication networks, such as private networks and the Internet. Such connections can include a wired connection or a wireless connection (e.g., using the IEEE 802.11 standard known in the relevant art) though it should be understood that network interface 208 can be practically any interface that enables communication to/from the processor 202.

Continuing with reference to FIG. 2, storage device(s) 210 can be included such as a hard disk drive, floppy disk drive, tape drive, CD-ROM or DVD drive, flash memory, rewritable optical disk, rewritable magnetic tape, or some combination of the above for storing program code, databases and application code. In certain implementations, memory 204, 206 and/or storage device(s) 210 are accessible by the processor 202, thereby enabling the processor 202 to receive and execute instructions stored on the memory 204, 206 and/or on the storage 210. Further, elements include one or more input devices 212 such as a keyboard, mouse, track ball and the like, and a display 214. The display 214 can include a screen or any other such presentation device that enables the system to instruct or otherwise provide feedback to the user regarding the operation of the system 100. By way of example, display 214 can be a digital display such as an LCD display, a CRT, an LED display, or other such 2-dimensional display as would be understood by those skilled in the art. By way of further example, a user interface and the display 214 can be integrated into a touch screen display. Accordingly, the display is also used to show a graphical user interface, which can display various data and provide “forms” that include fields that allow for the entry of information by the user. Touching the touch screen at locations corresponding to the display of a graphical user interface allows the user to interact with the device to enter data, control functions, etc. So, when the touch screen is touched, interface communicates this change to processor, and settings can be changed or user entered information can be captured and stored in the memory.

One or more software modules can be encoded in the storage device(s) 210 and/or in the memory 204, 206. The software modules can comprise one or more software programs or applications having computer program code or a set of instructions executed in the processor 202. Such computer program code or instructions for carrying out operations or aspects of the systems and methods disclosed herein can be written in any combination of one or more programming languages, as would be understood by those skilled in the art. The program code can execute entirely on one computing device (e.g., data processing apparatus 102) as a stand-alone software package, partly on one device and partly on one or more remote computing devices, such as, a user computing device 104, or entirely on such remote computing devices. In the latter scenario and as noted herein, the various computing devices can be connected to the data processing apparatus 102 through any type of wired or wireless network, including a local area network (LAN) or a wide area network (WAN), or the connection can be made to an external computer (for example, through the Internet using an Internet Service Provider). It should be understood that in some illustrative embodiments, one or more of the software modules can be downloaded over a network from another device or system via the network interface 208. For instance, program code stored in a computer readable storage device in a server can be downloaded over a network from the server to the storage 210.

It is to be appreciated that several of the logical operations described herein are implemented (1) as a sequence of computer implemented acts or program modules running on the various devices of the system 100 and/or (2) as interconnected machine logic circuits or circuit modules within the system 100. The actual implementation is a matter of design choice dependent on the requirements of the device (e.g., size, energy, consumption, performance, etc.). Accordingly, the logical operations described herein are referred to variously as operations, steps, structural devices, acts, or modules. As referenced above, the various operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Thus, the various components of data processing apparatus 102 need not be physically contained within the same chassis or even located in a single location. For example, as explained above with respect to databases which can reside on storage device 210, storage device 210 may be located at a site which is remote from the remaining elements of data processing apparatus 102, and may even be connected to CPU 202 across communication network 106 via network interface 208.

The nature of the present application is such that one skilled in the art of writing computer executed code (software) can implement the described functions using one or more or a combination of a popular computer programming languages and technologies including, but not limited to, C++, VISUAL BASIC, JAVA, ACTIVEX, HTML, XML, ASP, SOAP, IOS, ANDROID, TORR and various web application development environments.

As used herein, references to displaying data on user computing device 104 refer to the process of communicating data to the computing device across communication network 106 and processing the data such that the data can be viewed on the user computing device 104 display 214 using a web browser or the like. The display screens on user computing device 104 present areas within system 100 such that a user can proceed from area to area within the system 100 by selecting a desired link. Therefore, each user's experience with system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of system 100.

As used herein, the terms “function” or “module” refer to hardware, firmware, or software in combination with hardware and/or firmware for implementing features described herein. In the hardware sense, a module can be a functional hardware unit designed for use with other components or modules. For example, a module may be implemented using discrete electronic components, or it can form a portion of an entire electronic circuit such as an Application Specific Integrated Circuit (ASIC). Numerous other possibilities exist, and those of ordinary skill in the art will appreciate that the system can also be implemented as a combination of hardware and software modules. In the software sense, a module may be implemented as logic executing in a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware. Moreover, the modules described herein can be implemented as software modules, but may be represented in hardware or firmware. Generally, the modules described herein refer to logical modules that may be combined with other modules or divided into sub-modules despite their physical organization or storage.

Additional components, not shown, may also be part of the data processing apparatus 102 and/or user computing device 104, and, in certain embodiments, fewer components than that shown in FIG. 2 may also be used in data processing apparatus 102 and/or user computing device 104. Thus, the techniques are not limited to any specific combination of hardware circuitry and software, or to any particular source for the instructions executed by the data processing apparatus 102 and/or user computing device 104.

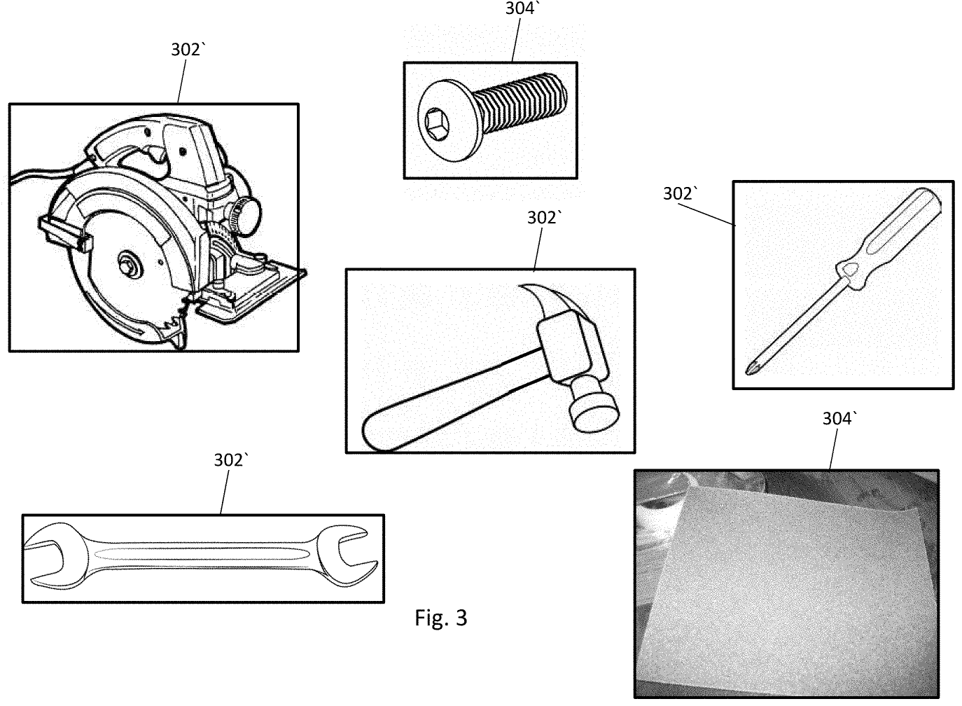

FIG. 3 is a simple diagram illustrating a plurality of example items that can be managed in accordance with the present application. For example, the equipment illustrated in FIG. 3 includes a power saw 302′, hammer 302′, screwdriver 302′ and wrench 302′. Example supplies/disposable items include bolt 304′ and sandpaper 304′. Of course, one skilled in the art will recognize that countless other types of equipment and supplies/disposable items are envisioned and suitable for implementations in accordance with the present application.

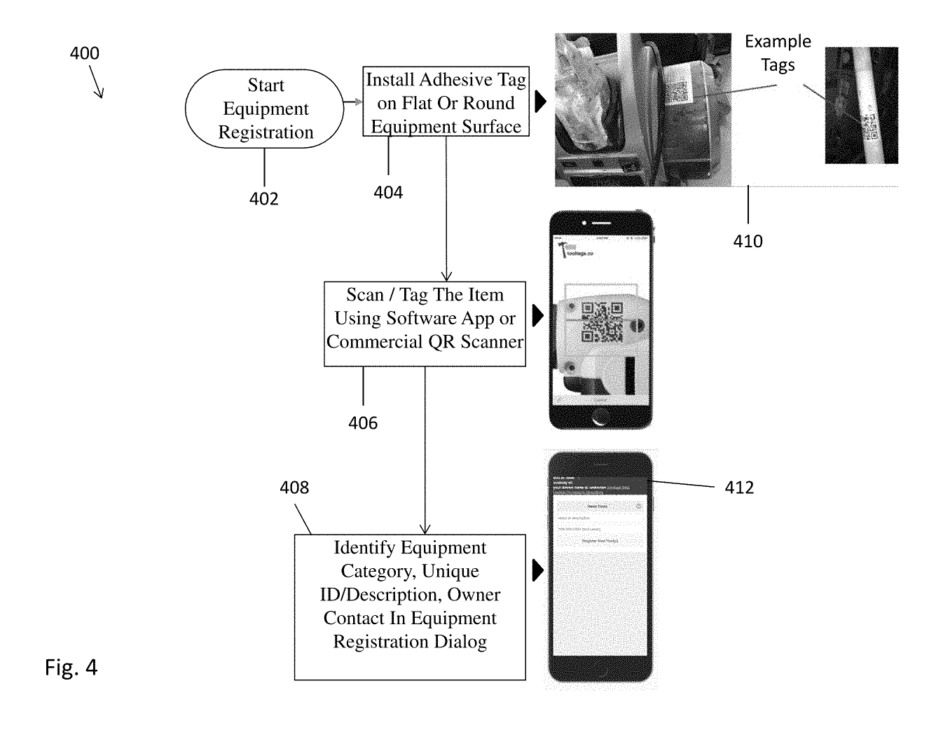

FIG. 4 is a process flow diagram of an example method representing interactions between backend processors (e.g., data processing apparatus 102) and one or more user computing devices 104 in accordance with registering a tool in one or more databases. The method 400 is implemented with any suitable computing device(s), such as a data processing apparatus 102 and/or user computing device 104 of FIG. 1. At step 402, the process begins, such as by a user selecting an option in a graphical user interface operating on a mobile computing device (user computing device 104). At step 404, an adhesive tag is installed on a flat or round surface associated with an item. The adhesive tag may have a machine-readable code affixed or printed thereon, such as a QR code. Alternatively, the adhesive tag may include a passive tag containing electronically stored information, such as a RFID tag. After installing the adhesive tag, the item is scanned, such as by a camera configured with a user computing device 104 and operating a software application (step 406). Other scanning technology may be used, such as a commercial barcode scanning device. During the registration process and after the scanning step 406, a data entry display form is automatically provided for the user to enter information associated with the tool being scammed. For example, the tool category, a unique idea or description of the tool, an owner contact in the tool and other suitable information can be submitted (step 408). Information submitted within the data entry form is preferably saved, such as in a cloud-based database, a local database stored on the user's computing device 104, or other storage. Example tags are illustrated at 410 and example data entry screens are shown at 411 and 412.

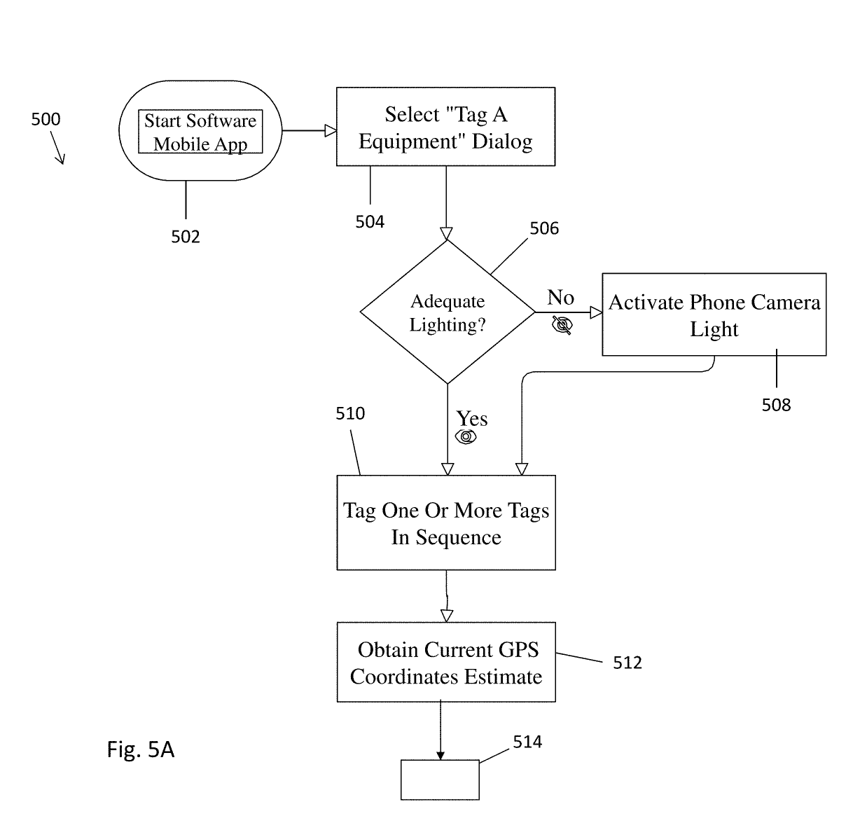

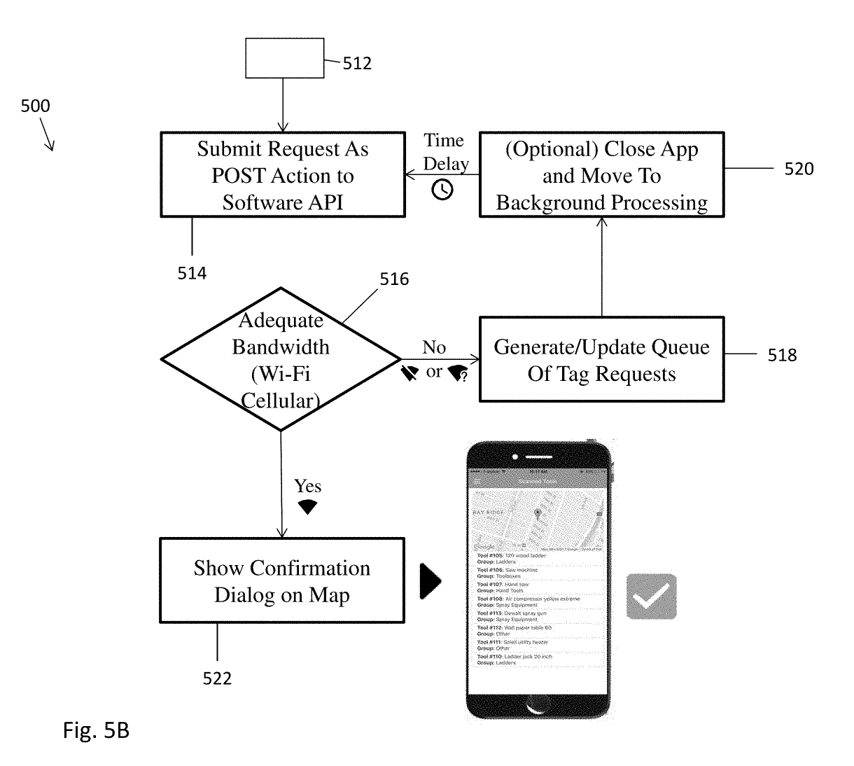

FIGS. 5A and 5B show a process flow diagram of an example method representing steps 500 associated with interfacing with one or more tools in accordance with the teachings herein. After launching a software application on a mobile user computing device 104 (step 502), a user selects an option to scan one or more barcodes that are affixed or otherwise coupled to a tool (step 504). At step 506, a determination is made whether the item being scanned is sufficiently illuminated. If not, one or more instructions are executed to cause a light to activate, such as a flash configured with the user's smartphone (step 508). If there is sufficient illumination, and/or if the device's light is activated in step 508, the process branches to step 510 and a scan of the barcode is performed. At the point of a successful scan of the tool by the user's computing device 104, a registration occurs that associates the user's device with the respective tool. At step 512, location information is obtained from the user computing device 104, such as via a global positioning system (“GPS”) module configured with the user computing device 104.

Continuing with the example process 500 and with particular reference to FIG. 5B, at step 514 a submission process, such as via a HTTP POST action to a database via respective API, is initiated. At step 516, a determination is made whether there is sufficient bandwidth (e.g., Wi-Fi or cellular data coverage) to execute the POST action. If not, then a queue within the user's computing device 104 is generated and/or updated comprising one or more tag requests (step 518). Thereafter, the process optionally branches to step 520, and the application is suspended to operate in the background, such as in connection with background processing. Thereafter, the process branches back to step 514, and the POST action is submitted. Alternatively, if the determination in step 516 is that adequate bandwidth exists, then a confirmation is received at step 522. In the example implementation shown in FIG. 5B, a graphical representation of a map is displayed and the respective items that have been scanned and transmitted via the POST action in step 514 are listed.

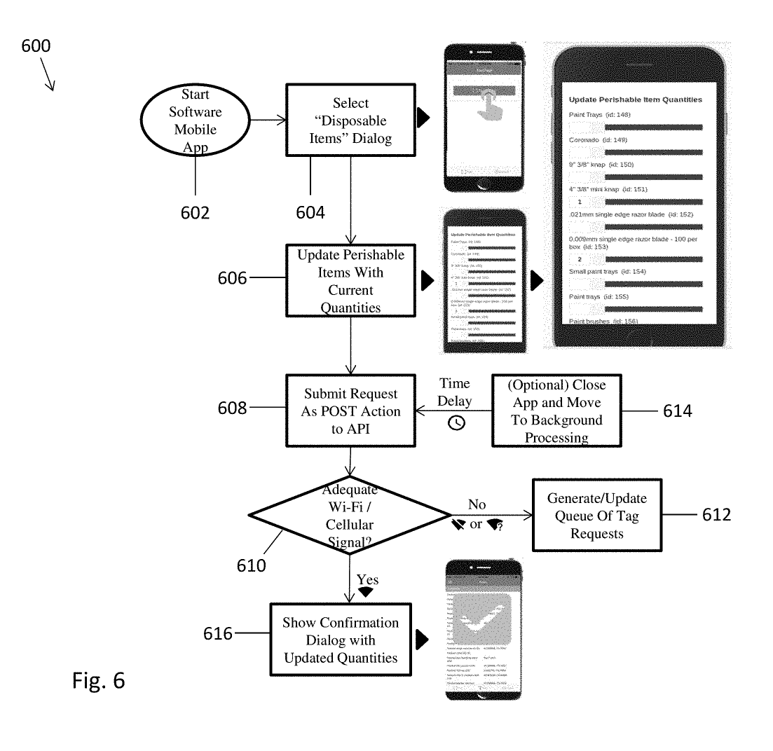

FIG. 6 shows a process flow diagram of an example method representing steps 600 associated with similar processes illustrated in FIG. 5, but for disposable items. After launching a software application on a mobile user computing device 104 (step 602), a user selects an option to scan one or more barcodes that are affixed or otherwise coupled to a disposable item (step 604). At step 606, entries are made by the user in a data entry display form provided on user computing device 104 for updating current quantities of specific items, such as paint trays, coronado, knap, razor blades, small paint trays, or the like. Of course one skilled in the art will recognize that virtually any disposable item, perishable items, supply or inventory is supported in connection with the present application. At step 608, a submission process, such as via a HTTP POST action to a database via respective API, is initiated. At step 610, a determination is made whether there is sufficient bandwidth (e.g., Wi-Fi or cellular data coverage) to execute the POST action. If not, then a queue within the user's computing device 104 is generated and/or updated comprising one or more tag requests (step 612). Thereafter, the process optionally branches to step 614, and the application is suspended to operate in the background, such as in connection with background processing. Thereafter, the process branches back to step 608, and the POST action is submitted. Alternatively, if the determination in step 610 is that adequate bandwidth exists, then a confirmation is received at step 616. In the example implementation shown in FIG. 6, a graphical representation of a map is displayed and the respective items that have been scanned and transmitted via the Post action in step 608 are listed.

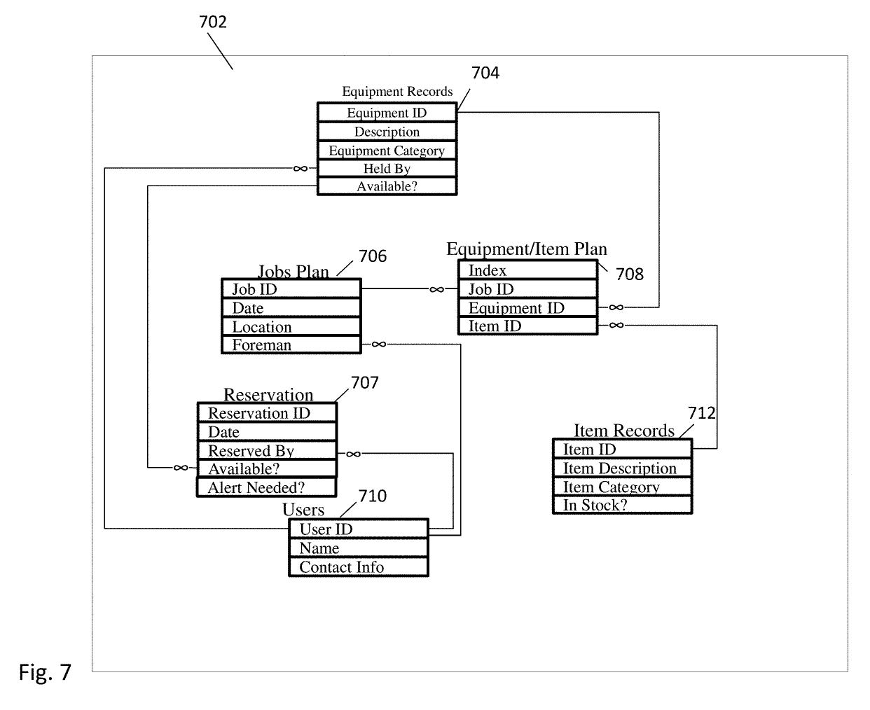

FIG. 7 illustrates an example database layout 702 in connection with a plurality of data structures, which can be configured as tables, linked lists, or other data storage resource. In the example shown in FIG. 7, the database comprises a relational set of sources. For example, equipment records 704 and item records 712 include placeholders for equipment and inventory or other supplies used in connection with the building industry. Equipment records 704 can include equipment ID (representing a unique identifier for a specific piece of equipment), description (representing a general classification or description of the piece of equipment), held by an individual user that has or is using the piece of equipment) and available (representing whether a piece of equipment is available or not, such as due to being in use, reserved, misplaced or the like).

Continuing with reference to FIG. 7, item records 712 can include ID (representing a unique identifier for specific supply or disposable item), item description (representing a general classification or description of the item), item category (representing a categorization of a specific item) and in stock (representing whether an item is available). Users 710 can include user ID (representing a unique identifier for specific person), user name and contact information, which can include, for example, address information, cell phone information, email address, or the like. Jobs plan 706 can include, for example, job ID (representing a unique identifier for a specific job), date, location, and determine (representing an assigned foreman for a specific job). Equipment/item plan 708 can include an index value (representing a unique value for database indexing), specific job ID, equipment ID, and item ID. Moreover, reservation 707 can include reservation ID (representing a unique identifier for a specific reservation), date, reserved by (representing a specific person who made a reservation for a specific piece of equipment), available (representing whether the reserved piece of equipment is available or not) and alert needed (representing whether an alert should be generated and transmitted to a user. For example, a builder who forgets to return a tool to a specific location needs to be alerted to return the tool. Also as shown in FIG. 7 are respective connections, identifying one to one and one to many relationships, in connection with data normalization.

Of course, one of ordinary skill will recognize that the example database layout 702 shown in FIG. 7 is shown for example purposes, and that other record layouts, data structures and relationships are supported by the teachings herein. Moreover, can be appreciated that the example database structure and layout illustrated in FIG. 7 is usable to store and access information, and to process the information for convenient and informative displays, reports and data entry/editing processes.

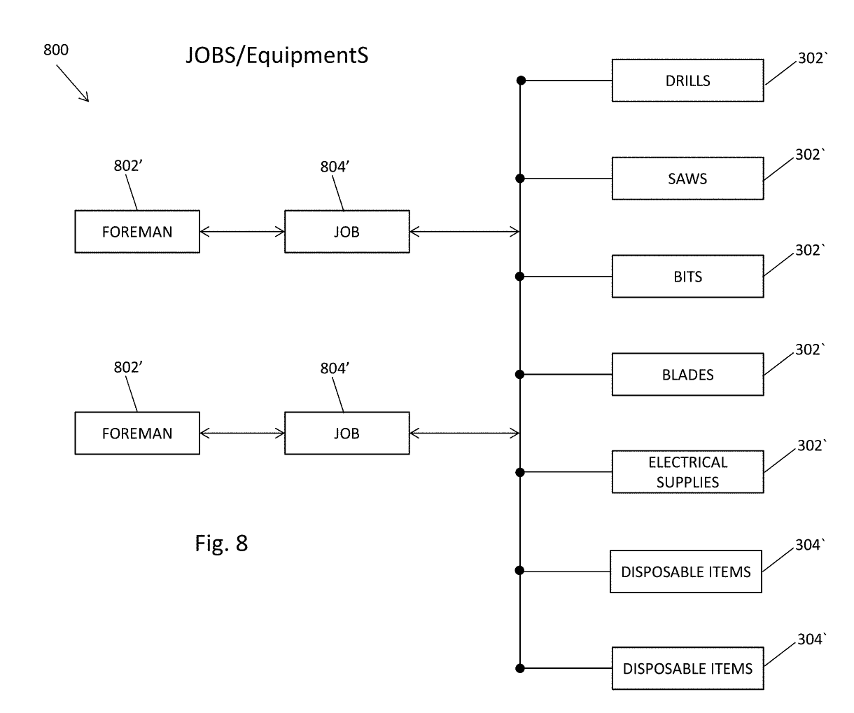

FIG. 8 is a simple block diagram illustrating interactivity between various user computing devices 104 in connection a foreman, job and specific example equipment and items associated therewith. For example, foreman 802′ and jobs 804′ are shown that corresponding, for example, with the respective data structures and database 702 (FIG. 7). For example, a foreman who is preparing for a week of work launches a software application configured on her user computing device 104, and selects a respective job 804′. One or more data processing steps take place that associate the respective job, such as by a job ID, with equipment 302′ and items 304′ to be used on the job. While perusing the results, the foreman 802′is notified that a special drill 302′ and drill bit 302′ needed for the job is unavailable. Moreover, the software application operating on the foreman's 802′ user computing device 104 grams to generate and transmit an alert to the user who had last checked out the drill and it combination. The foreman 802′ selects an option to proceed, and the alert is generated and transmitted to the user computing device 104 of the respective user.

Thus and as shown and described herein, the present application provides for identifying a plurality of equipment and other items, and associating each of the respective items in respective inventory database applications. In accordance with the respective features shown and described herein, current and up-to-date information is maintained and made accessible by all interested parties at any time. This can be implemented, for example, as a function of QR codes, NFC or other convenient data sources that are coupled to or otherwise configured with the items and include one or more uniform resource locators (“URLs”), including to access and populate Web-based databases using simple scanning technology. In one or more configurations, image recognition technology can be employed to preclude a need for coupling items with machine-readable codes or other data objects. For example, a picture can be taken of a respective tool using a smart phone or other mobile user computing device 104. The picture of the tool can be processed to recognize, for example, a serial number, a model, or even a general category or classification of tool. By processing one or more images associated with a respective item or equipment, significant data entry applications are simplified or otherwise eliminated.

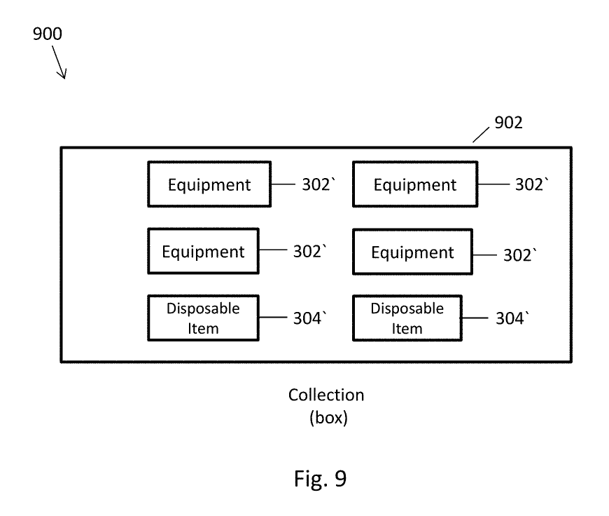

FIG. 9 is a simple block diagram and illustrates an example container, such as a carrying case that holds a collection 902 of equipment and items. For example, a building company may group various tools 302′and corresponding items 304′ for easy and convenient access. In one or more implementations, by taking a simple picture of the contents of a carrying case, one or more processes executing on user computing device 104 and/or data processing apparatus 102 can determine that a respective item is missing. Thereafter, and in accordance with the features shown and described herein, the whereabouts of the respective item can be determined and the person responsible can be notified substantially automatically to rectify the shortcomings.

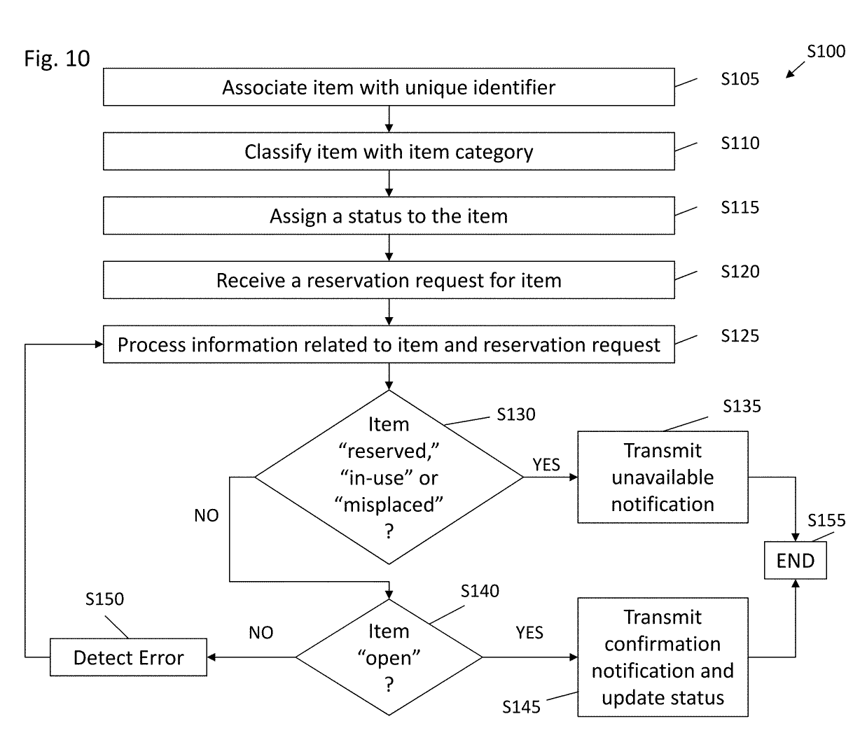

FIG. 10 shows a process flow diagram of another example method representing steps S100 associated with reserving one or more items in accordance with the teachings herein. At step S105, an item is associated with a unique identifier. At step S110, the item is classified with an item category. At step S115, a status is assigned to the item. The status can include a respective location for the item and a respective availability state for the item. For instance, in one or more implementations, the item can be assigned an availability state of “open,” “reserved,” “in-use,” or “misplaced.” At step S120, a reservation request for the item is received from a user computing device. The reservation request can represent a request for exclusive use of the respective item. Further, the reservation request can include a respective date and/or time, and a location for using the item. At step S125 information related to the item that is associated with the reservation request is processed. In one or more implementations, the information can be processed to determine the respective status (e.g., availability state) of the item. At step S130 it determined whether the item associated with the reservation request has an availability state of “reserved,” “in-use,” or “misplaced.” Where the item has one of these three availability states, an unavailability notification is transmitted to the user computing device indicating that the respective item is “reserved,” “in-use,” or “misplaced” (step S135). Where the item is not “reserved,” “in-use,” or “misplaced,” it is determined whether the item associated with the reservation request has an availability state of “open” (step S140). Where the item has an availability state of “open,” a confirmation notification is transmitted to the user computing device indicating that the respective item is available and confirming reservation of the respective item (step S145). Additionally, at step S145 the respective status (e.g., availability state) of the respective item is updated to represent that the item is “reserved” or “in-use.” Where the item does not have an availability state of “open,” (step S140), an error is detected (step S150) and the method returns to step S125. At step S155, the method ends.

Thus, in accordance with the teachings herein, hundreds of thousands of items owned or otherwise controlled by multitudes of businesses that are in high demand can be managed efficiently and accurately, thereby reducing or otherwise eliminating any delays or inconveniences caused by the items being unavailable or having unknown whereabouts.

The subject matter described herein is provided by way of illustration only, and should not be construed as limiting. Various modifications and changes can be made to the subject matter described herein without following the example implementations illustrated and described, and without departing from the true spirit and scope of the present application.

What is claimed:

1. A method comprising:
associating, by at least one processor configured to execute instructions stored on a non-transitory readable media, a respective item with a unique identifier;
classifying, by the at least one processor, the respective item with a respective item category;
assigning, by the at least one processor, a respective status to the item, wherein the respective status comprises a respective location and a respective availability state for the item, wherein the availability state is open, reserved, in-use, or misplaced;
receiving, by the at least one processor from a first user computing device over a communication network, a respective reservation request associated with the respective item, wherein the respective reservation request represents a request for exclusive use of the respective item and wherein the respective reservation request includes a respective date and/or time, and a location for using the respective item; and
processing, by the at least one processor, information related to the respective item associated with the reservation request to determine the respective status of the item, wherein the processing step comprises:
where the availability state of the respective item is reserved, in-use, or misplaced:
transmitting, by the at least one processor to the first user computing device, an unavailable notification indicating that the respective item is reserved, in-use, or misplaced; or
where the availability state of the respective item is open:
transmitting, by the at least one processor to the first user computing device, a confirmation notification representing that the respective item is available and confirming reservation of the respective item; and
updating, by the at least one processor, the respective status to represent that the respective item is reserved or in-use.

2. The method of claim 1, further comprising:
receiving, by the at least one processor from the first user computing device, a completion notification representing completed use of the respective item; and
updating, by the at least one processor, the respective status to represent that the respective item is available.

3. The method of claim 2, wherein the completion notification includes information representing a location of the respective item, and a date and/or time of transmission of the completion notification.

4. The method of claim 1, wherein the respective reservation request represents a request to reserve use of the respective item in the present or in the future.

5. The method of claim 1, further comprising:
after transmitting the unavailable notification by the at least one processor to the first user computing device, receiving, by the at least one processor from a different user computing device, a completion notification representing availability of the respective item; and
updating, by the at least one processor, the respective status of the respective item to represent that the respective item is available.

6. The method of claim 5, further comprising:
transmitting, by the at least one processor to the first user computing device, an alert indicating that the respective item having the respective item category has an availability state of open.

7. A system comprising:
one or more user computing devices including a first user computing device;
at least one processor comprising a non-transitory readable media, wherein the non-transitory readable media is configured store instructions; and
a communication network configured to facilitate communication between the at least one processor and the one or more user computing devices including the first user computing device;
wherein the at least one processor is configured to execute instructions that cause the at least one processor to:
associate a respective item with a unique identifier;
classify the respective item with a respective item category;
assign a respective status to the item, wherein the respective status comprises a respective location and a respective availability state for the item, and wherein the availability state is open, reserved, in-use, or misplaced;
receive, from the first user computing device, a respective reservation request associated with the respective item, wherein the respective reservation request represents a request for exclusive use of the respective item and wherein the respective reservation request includes a respective date and/or time, and a location for using the respective item; and
process information related to the respective item associated with the reservation request to determine the respective status of the item, wherein as part of the processing of information, the at least one processor is further configured to execute instructions that cause the at least one processor to:
where the availability state of the respective item is reserved, in-use, or misplaced:
transmit, to the first user computing device, an unavailable notification indicating that the respective item is reserved, in-use, or misplaced; or
where the availability state of the respective item is open:
transmit, to the first user computing device, a confirmation notification representing that the respective item is available and confirming reservation of the respective item; and
update the respective status to represent that the respective item is reserved or in-use.

8. The system of claim 7, wherein the at least one processor is configured to execute instructions that cause the at least one processor to:
receive, from the first user computing device, a completion notification representing completed use of the respective item; and
update the respective status to represent that the respective item is available.

9. The system of claim 8, wherein the completion notification includes information representing a location of the respective item, and a date and/or time of transmission of the completion notification.

10. The system of claim 7, wherein the respective reservation request represents a request to reserve use of the respective item in the present or in the future.

11. The system of claim 7, wherein the at least one processor is configured to execute instructions that cause the at least one processor to:
after transmission of the unavailable notification by the at least one processor to the first user computing device:
receive, from a different user computing device, a completion notification representing availability of the respective item; and
update the respective status of the respective item to represent that the respective item is available.

12. The system of claim 11, wherein the at least one processor is configured to execute instructions that cause the at least one processor to:
transmit, to the first user computing device, an alert indicating that the respective item having the respective item category has an availability state of open.
